(19) United States
(12) Patent Application Publication
(10) Pub. No.: US 2012/0159146 A1
(43) Pub. Date: Jun. 21, 2012

(54) System and Method for Transcoding Content

(75) Inventors: John P. Kamieniecki, Lafayette Hill, PA (US); Kevin T. Chang, Doylestown, PA (US)

(73) Assignee: GENERAL INSTRUMENT CORPORATION, Horsham, PA (US)

(21) Appl. No.: 12/973,449

(22) Filed: Dec. 20, 2010

(51) Int. Cl. H04K 1/00; G06F 21/00

(52) U.S. Cl. 713/150; 726/26

(57) ABSTRACT

A system is provided for use with secure content in a first format. The system includes a conditional access device, a transcoding device and a media processor. The conditional access device is arranged to receive the secure content and can generate second secure content based on the secure content. The conditional access device is can further provide the second secure content to the transcoding device. The transcoding device can transcode the second secure content into transcoded content of a second format, can secure the transcoded content as secure transcoded content and can provide the secure transcoded content to the media processor.

### BACKGROUND

The present invention relates to the field of digital media, in particular, transcoding of media content in digital cable systems.

In digital cable systems, it is desirable to prevent the unauthorized access of certain content as it crosses from a conditional access device, a non-limiting example of which includes a Cable Card, to a Host (set-top terminal) on the Card-Host interface. Cablelab's “CableCard Copy Protection 2.0 Specification” (OP-SP-CCCP2.0) defines procedures and methods for a compliant Multi-stream Cable Card (M-card) and a host media processor (Host) to securely communicate and negotiate encryption keys needed for providing copy protection of high value content across the M-card-Host Cable Card InterFace (CCIF). These procedures authenticate the M-card and Host pair and bind them together using a Diffie-Hellman key exchange. This exchange is based in part upon Cablelab's Certificate Authority based x.509 certificates that are stored in the M-card and the Host. In addition to securing the content connection between M-card and the Host for High Value media content, it also provides for conditional access (CA) system validation and revocation in the event of a device/product compromise.

A CA system provides a private way to communicate command/control information to the M-card including validation of the M-card and Host combination. An M-card and the Host complete the binding process after mutual authentication and the validation by the CA system. In the event the integrity of a Host becomes compromised, the CA system also provides a way to communicate a Certificate Revocation List (CRL) to the M-card, which can in turn disable the high value media content exchange to a compromised Host. A properly bound M-card and Host will jointly compute Copy Protection (CP) keys as necessary and according to OP-SP-CCCP2.0 specification in order to secure high value media content as it flows from the M-card to the Host.

FIG. 1 illustrates a block diagram for a prior art set top box (STB) 100.

As illustrated in the figure, STB 100 includes a connector 102, a diplex filter 104, an out-of-band (OOB) modulator 106, an OOB demodulator 108, an M-card 110, an in-band (IB) tuner 112, an IB tuner 114, a host media processor 116, a flash memory 118, a system DRAM 120, a hard disk drive (HDD) 122 and peripheral devices 124.

In this example, each of diplex filter 104, OOB modulator 106, OOB demodulator 108, M-card 110, tuner 112, tuner 114, host media processor 116, flash memory 118, system DRAM 120 and HDD 122 are distinct devices. However, in other embodiments, at least two of diplex filter 104, OOB modulator 106, OOB demodulator 108, M-card 110, tuner 112, tuner 114, host media processor 116, flash memory 118, system DRAM 120 and HDD 122 may be combined as a unitary device. Further, in some embodiments at least one of diplex filter 104, OOB modulator 106, OOB demodulator 108, M-card 110, tuner 112, tuner 114, host media processor 116, flash memory 118, system DRAM 120 and HDD 122 may be implemented as computer-readable media for carrying or having computer-executable instructions or data structures stored thereon. Such computer-readable media can be any available media that can be accessed by a general purpose or special purpose computer. Non-limiting examples of computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (hardwired and/or wireless, or a combination of hardwired or wireless) to a computer, the computer properly views the connection as a computer-readable medium. Thus, any such connection is properly termed a computer-readable medium. Combinations of the above should also be included within the scope of computer-readable media.

Diplex filter 104 is operable to receive a broadband signal 126 from connector 102 and an OOB modulated signal 128 from OOB modulator 106. Broadband signal 126 may be an input signal from a cable company or a satellite, available via connector 102. Diplex filter 104 performs frequency domain multiplexing between broadband signal 126, which may be a multiplex of IB downstream bound high frequency signals and OOB modulated signal 128, which may be an upstream bound low frequency signal. Downstream information provided by broadband signal 126 may include video, audio, multimedia and/or data.

OOB modulator 106 is operable to receive an OOB signal 132 from M-card 110 and to provide OOB modulated signal 128 to diplex filter 104. OOB modulator 106 is also known as Return Path Transmitter (RPT), which is used to transmit the low frequency upstream information destined for the head-end server. Upstream information provided by OOB modulated signal 128 may include video, audio, multimedia and/or data.

OOB demodulator 108 is operable to receive a diplex filter output signal 130 and to provide an OOB demodulated signal 134 to M-card 110. Traditionally, OOB demodulator 108 receives CA control information about the media content on a narrowband carrier, which it passes on to M-card 110.

M-card 110 is operable to receive OOB demodulated signal 134, a data input signal 138 and a CPU interface signal 136 from host media processor 116 and to provide OOB signal 132 and a data output signal 140. M-card 110 receives media access control messages from the head-end server via OOB demodulated signal 134 and forwards them to host media processor 116 via signal 136. M-card 110 performs any conditional access and decryption functions based on the media access control messages, which may contain information about configurations, authorizations, entitlements, etc. of the media content received by tuner 112 and tuner 114. M-card 110 receives CA encrypted media content via signal 138 from host media processor 116, and if authorized, decrypts the media content and passes it back to host media processor 116 via signal 140. If the copy protection rules are such that signal 140 needs to be protected then M-card 110 may encrypt signal 140 for copy protection, otherwise signal 140 may not be encrypted. CPU interface signal 136 is used for exchanging control information between M-card 110 and host media processor 116.

Tuner 112 and Tuner 114 receive encrypted media content from diplex filter 104. Tuner 112 performs in-band tuning of diplex filter output signal 130 and provides a baseband signal 142 to host media processor 116. Similarly, Tuner 114 performs in-band tuning of diplex filter output signal 130 and provides another baseband signal 144 to host media processor 116. There are only two tuners shown in FIG. 1, however, there may be any number of tuners connected to host media processor 116.

Host media processor 116 interfaces with M-card 110 for a two-way communication using CPU interface signal 136. It receives encrypted media content from tuner 112 and tuner 114 and provides the encrypted media content via signal 138 to M-card 110. Media content received from M-card 110 via signal 140 may or may not re-encrypted. Depending on the copy rights, host media processor 116 may store the media content on HDD 122 or provide it to peripheral device 124 via a peripheral interface 152. Note that there is a plurality of peripheral devices with their corresponding interfaces, however, they are grouped as a peripheral device 124 with a peripheral interface 152 for convenience. Host media processor 116 interfaces with flash memory 118 via an external bus interface signal 146. Host media processor 116 also interfaces with system DRAM 120 via a DRAM interface signal 148.

As discussed above with reference to FIG. 1, prior art STB 100 receives encrypted media content from a broadband input along with CA control. It represents a separable security system including a CableCard and a Host. The CableCard and the Host are paired together, both in physical sense and security sense. They exchange information back and forth and ultimately the content is passed to the CA device, which decrypts it and removes any conditional access encryption. The CA device reapplies a copy protection encryption method to protect the content before providing it back to the Host. Host can CP decrypt the content, decode it, store it or send it out as needed. This is further explained using FIG. 2.

FIG. 2 illustrates a functional diagram for prior art STB 100.

FIG. 2 includes M-card 110, host media processor 116, a card certificate 202, a host certificate 204 and a cable head-end command and control block 232. M-card 110 further includes a CP processing block 206, a CA decrypt block 210 and a CP encrypt block 212. Host media processor 116 further includes a CP processing block 208 and a CP decrypt block 214.

CP processing block 208 and CP decrypt block 214 are functional elements that may be contained in a single device or separate devices. Those of skill in the art would appreciate that the functions performed by a single device may provide increased security. Further, in some embodiments at least one of CP processing block 208 and CP decrypt block 214 may be implemented as computer-readable media for carrying or having computer-executable instructions or data structures stored thereon.

CP processing block 206, CA decrypt block 210 and CP encrypt block 212 are functional elements that may be contained in a single device or separate devices. Those of skill in the art would appreciate that the functions performed by a single device may provide increased security. Further, in some embodiments at least one of CP processing block 206, CA decrypt block 210 and CP encrypt block 212 may be implemented as computer-readable media for carrying or having computer-executable instructions or data structures stored thereon.

Card certificate 202 and host certificate 204 represent the identity of M-card 110 and host media processor 116, respectively. Initially, card certificate 202 is loaded into M-card 110 and host certificate 204 is loaded into host media processor 116. Certificates may be loaded into these devices via a number of known ways. Cable head-end command and control signal 232 is similar to OOB demodulated signal 134 and includes CA entitlement and a pairing function to validate the compatibility of M-card 110 and host media processor 116. M-card 110 and host media processor 116 mutually authenticate each other using mutual authentication and Diffie Hellman exchange information 220. The Diffie Hellman method allows two entities to jointly establish a shared secret key over a communication link, without having any prior knowledge of each other. M-card 110 and host media processor 116 jointly generate a CP key 222, which is used by CP encrypt block 212 via an information signal 228 and passed it over to a CP encrypted content 226. Diffie Hellman exchange information 220 and CP key 222 together represent CPU interface signal 136.

CA decrypt block 210 receives CA encrypted content 224 from host media processor 116, which has been encrypted by any known encryption method. CP processing block 206 provides information signal 228 to CP encrypt block 212 in order to decide whether CA decrypted data 230 needs to be re-encrypted. If CP encrypted content 226 has been encrypted, then it needs to be decrypted by CP decrypt block 214, controlled by an information signal 234 provided by CP processing block 208.

As discussed with reference to FIG. 1 and FIG. 2, STB 100 represents a separable security system including a CableCard and a Host. The CableCard and the Host exchange information back and forth and ultimately the content is passed to the CA device, which decrypts it and removes any conditional access encryption. It reapplies a copy protection encryption method to protect the content before providing it back to the Host. Host can CP decrypt the content, decode it, store it or send it out as needed.

What is needed is a system and method for transcoding the media content while adhering to the copy protection requirements and without the above mentioned challenges.

### BRIEF SUMMARY

The present invention provides a system and method for transcoding the media content over an existing interface between the M-card and the host media processor. By placing the transcoder in between the M-card and the host media processor and using the existing interface for transcoding, minimizes the additional steps of CP decrypting and CP encrypting and therefore requires much lower use of encryption and decryption processing resources.

In accordance with an aspect of the present invention, a system is provided for use with secure content in a first format. The system includes a conditional access device, a transcoding device and a media processor. The conditional access device is arranged to receive the secure content and can generate second secure content based on the secure content. The conditional access device is can further provide the second secure content to the transcoding device. The transcoding device can transcode the second secure content into transcoded content of a second format, can secure the transcoded content as secure transcoded content and can provide the secure transcoded content to the media processor.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a block diagram for a prior art STB configuration;

FIG. 2 illustrates a functional diagram for the prior art STB of FIG. 1;

FIG. 3 illustrates a block diagram for an example STB with a transcoder;

FIG. 4 illustrates a functional diagram for the STB of FIG. 3 with a transcoder;

FIG. 5 illustrates a STB configuration with an inline transcoder, in accordance with an aspect of the invention; and

FIG. 6 illustrates a functional diagram for the STB configuration of FIG. 5, in accordance with an aspect of the invention.

### DETAILED DESCRIPTION

Aspects of the invention provide a system and method for securely transferring media content from a conditional access device to a transcoder, transcoding the media content from one format to another format with the transcoder, and then securely transferring the transcoded media content to a host media processor. The media content is “securely transferred” when it is inaccessible to all but the intended receiver. Accordingly, when the media content is securely transferred from the conditional access device to the transcoder, the data will be inaccessible to anyone but the transcoder. Similarly, when the transcoded media content is securely transferred from the transcoder to the host media processor, the data will be inaccessible to anyone but the host media processor.

In a non-limiting example embodiment described herein, the conditional access device is an M-card.

In a non-limiting example embodiment, a transcoder securely receives media content from a conditional access device by way of an encryption system, wherein the conditional access device encrypts the media content, and the transcoder decrypts the media content. In other example embodiments, any secure communication system, method or protocol may be used. For purposes of explanation, an example embodiment described herein includes an encryption system for securely transferring media content from the conditional access device to the transcoder.

In a non-limiting example embodiment, a host media processor securely receives transcoded media content from a transcoder by way of an encryption system, wherein the transcoder encrypts the media content, and the host media processor decrypts the transcoded media content. In other example embodiments, any secure communication system, method or protocol may be used. For purposes of explanation, an example embodiment described herein includes an encryption system for securely transferring transcoded media content from the transcoder to the host media processor.

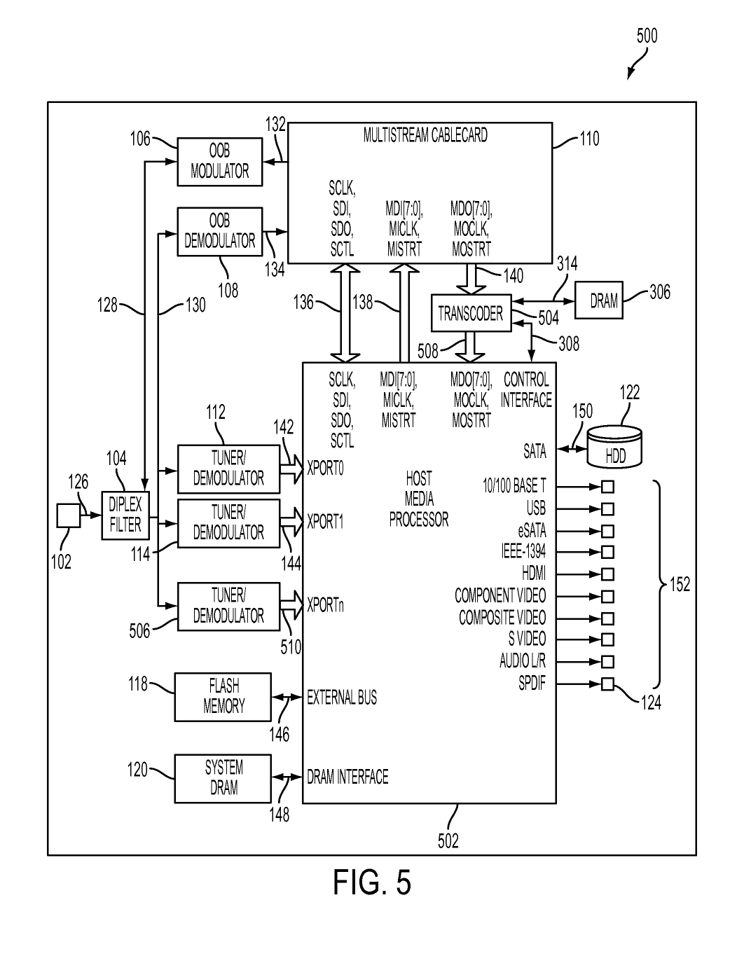

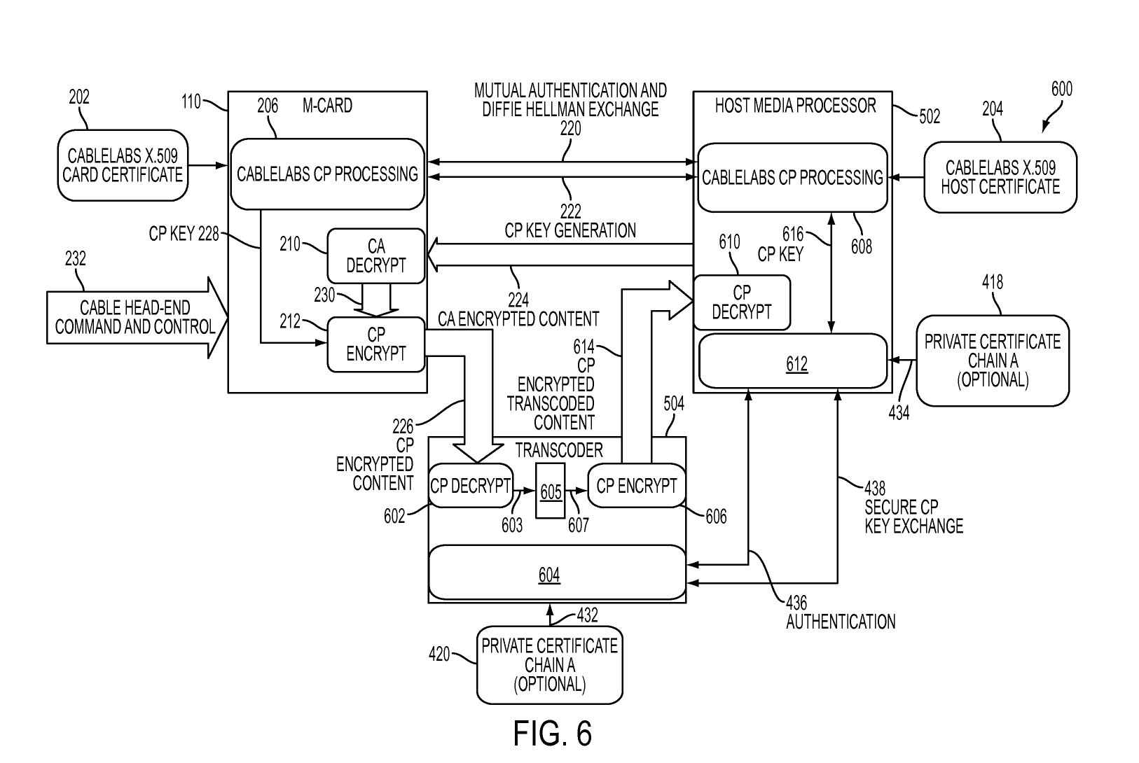

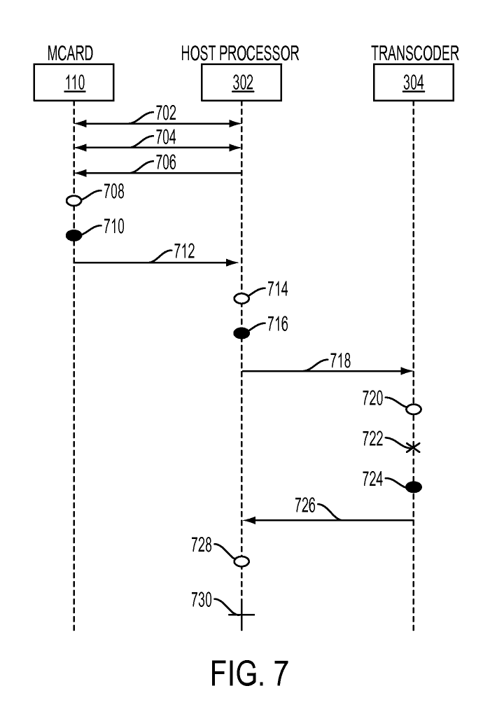

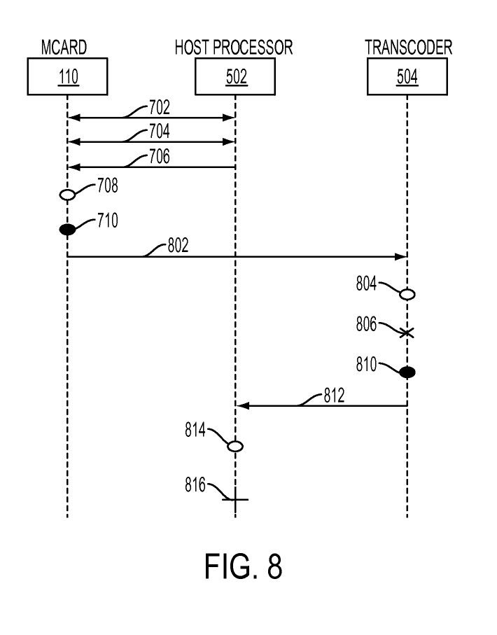

Disposing the transcoder between the M-card and the host media processor and using the existing interface for transcoding, minimizes the additional steps of private encrypting and private decrypting and therefore requires much lower use of encryption and decryption processing resources. This will be further explained below using FIGS. 5-6. However, transcoding of secure content will first be described.

Video format transcoding is a conversion of video content from one format into another format between different types of video devices. Video format transcoding is a valuable feature within set-top box (STB) architectures. Transcoding allows for contents to be broadcast in formats that are already in use, such as MPEG-2 (Moving Picture Experts Group-2), but then converted into an advanced format, such as MPEG-4 that allows for the content to consume less capacity on hard disk drives, in the case of Digital Video Recorder (DVR) applications, and consume less bandwidth on home networks, in the case of multi-room DVR, or other streaming applications. Other uses of transcoding include reformatting High Definition (HD) and Standard Definition contents into formats suitable to be viewed on mobile handsets with smaller screen sizes.

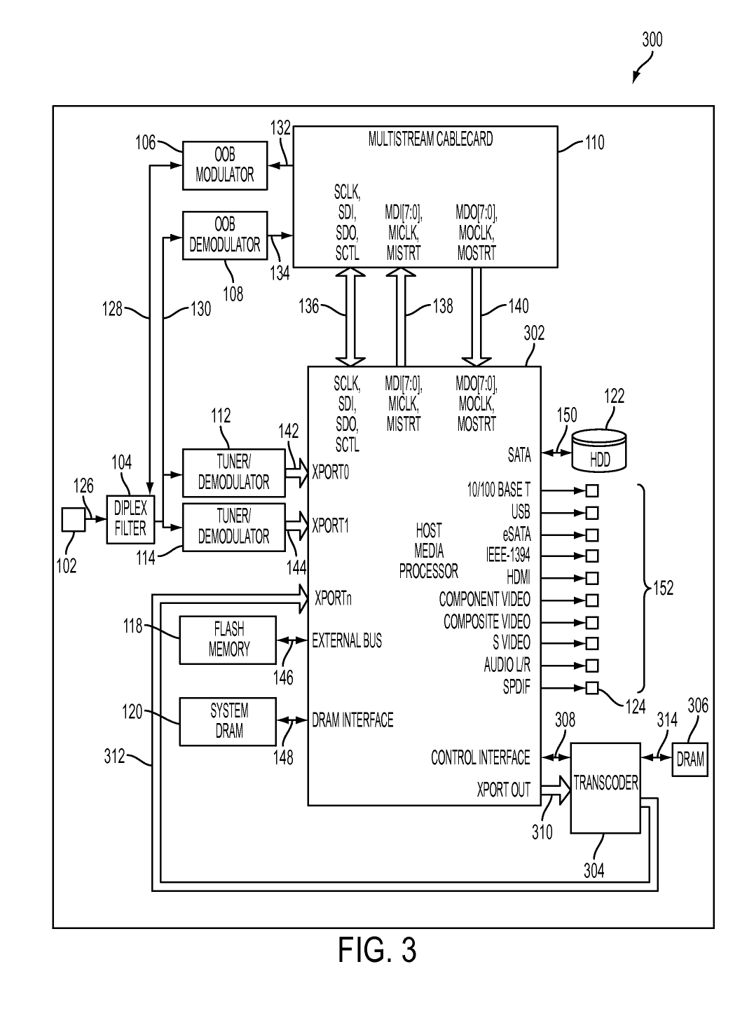

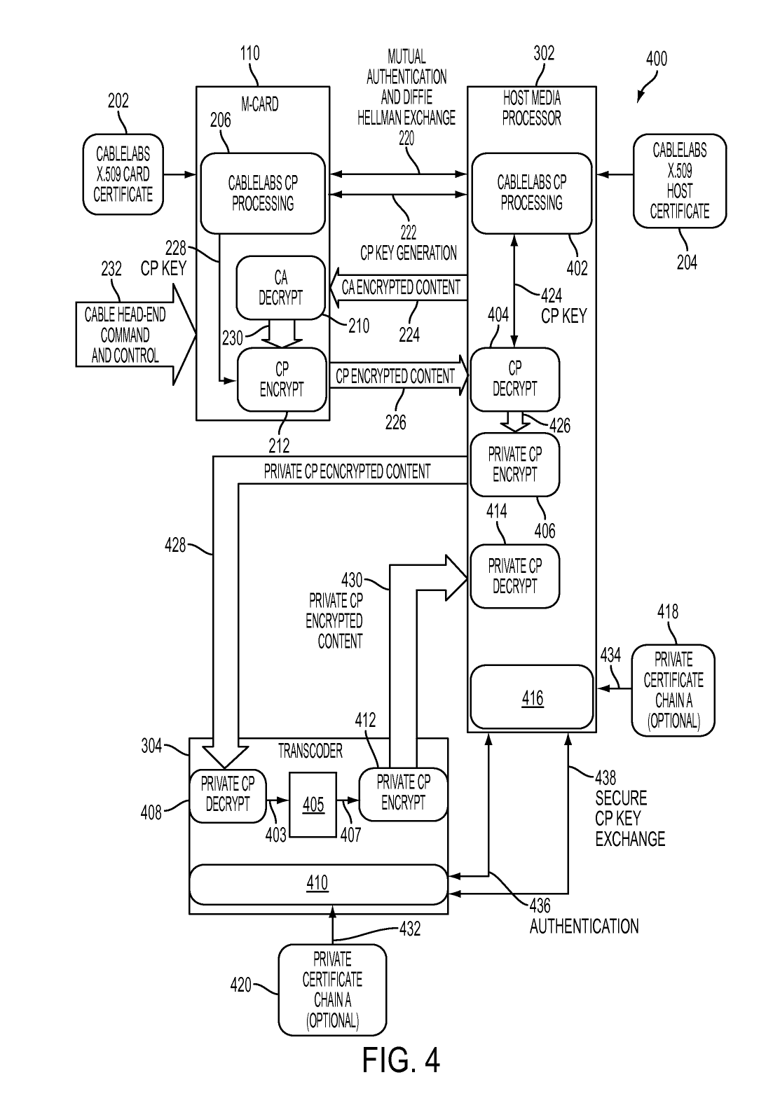

The OpenCable 2.0 Host specifications have a mandatory requirement for MPEG-2 video decode, but not MPEG-4/H.264. In order to support new and more efficient digital video encoding schemes, for example, MPEG-4, has raised a need for a transcoder in order to switch between different video formats. An example STB with a transcoder will now be discussed further using FIGS. 3-4.

FIG. 3 illustrates a block diagram for an example STB 300 with a transcoder.

FIG. 3 includes all the elements of prior art STB 100 in addition to a transcoder 304 and a DRAM 306, and host media processor 116 has been replaced with an updated host media processor 302.

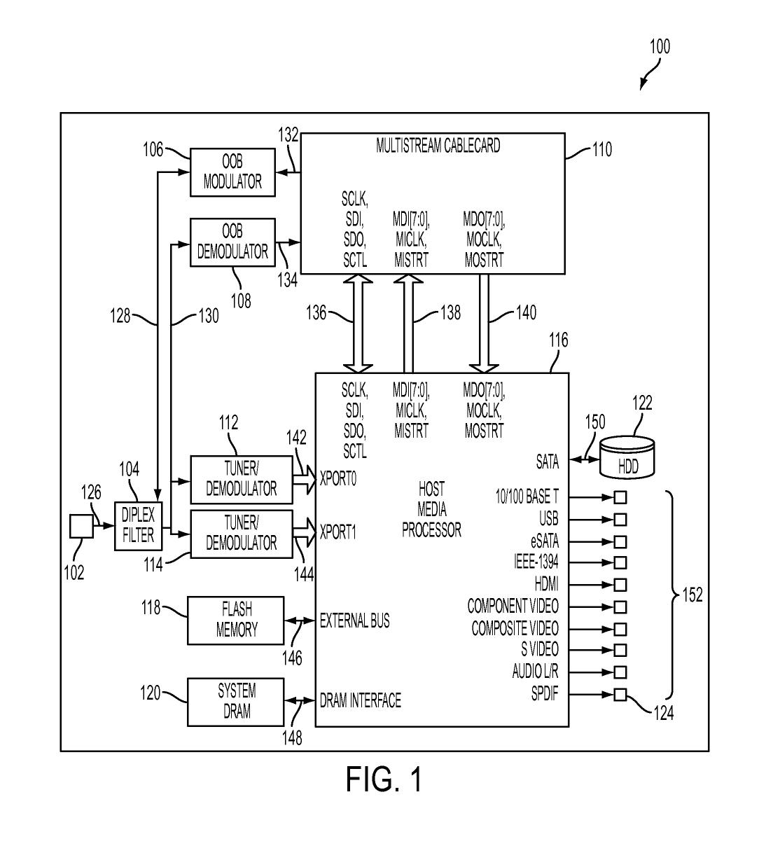

High level operation of STB 300 is similar to STB 100 as described earlier with reference to FIG. 1, except with the introduction of transcoder 304, there is an obligation to copy protect the content going in and out of transcoder 304. As illustrated in FIG. 3, transcoder 304 receives media content via a data signal 310 and controls via a control interface signal 308. DRAM 306 provides working memory for transcoder 304 via a DRAM interface signal 314.

As discussed above with reference to FIG. 1, host media processor 302 receives media content from M-card 110, which may or may not be encrypted depending on the copy rights. Host media processor 302 can store this content on HDD 122, send it out to peripheral device 124 or transcode it using transcoder 304. If this media content is encrypted, then transcoder 304 decrypts the contents, transcodes it, encrypts it again and sends it back to host media processor 302 via a data signal 312. Host media processor 302 can provide this newly encrypted and transcoded media content to peripheral device 124 via peripheral interface 152. This is further explained using FIG. 4.

FIG. 4 illustrates a functional diagram for STB 300 with a transcoder.

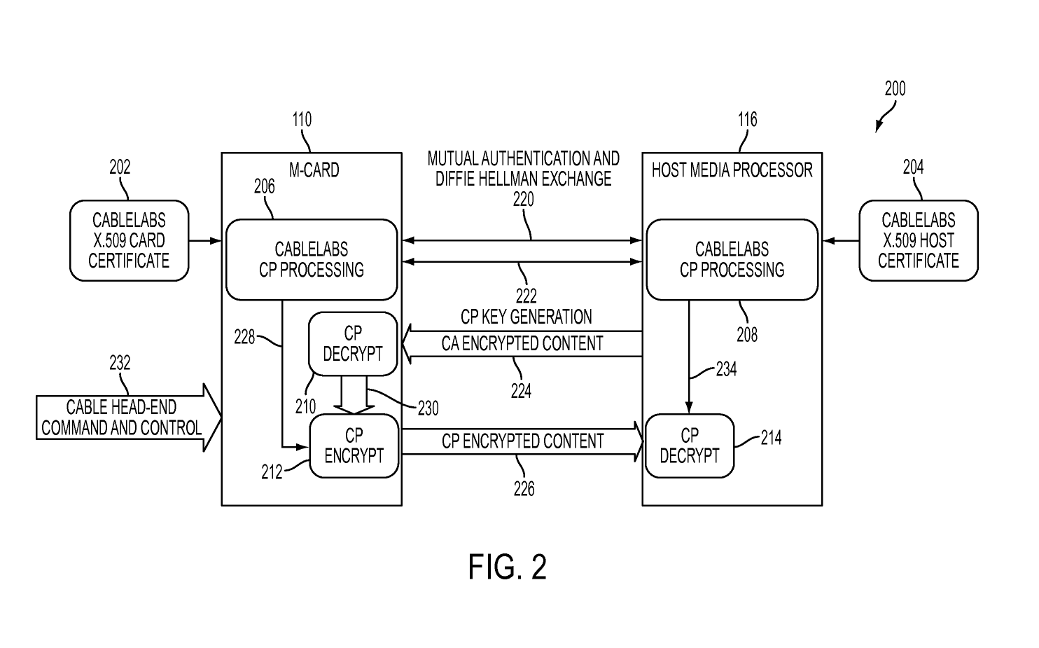

FIG. 4 includes all the elements of FIG. 2 in addition to transcoder 304, host media processor 302, a private certificate chain A 418 and another private certificate chain A 420. Host media processor 302 now includes a CP processing block 402, a CP decrypt block 404, a private CP encrypt block 406, a private CP decrypt block 414, a private security/authentication block 416. Transcoder 304 further includes a private CP decrypt block 408, a private CP encrypt block 412, a transcoding portion 405 and a private security/authentication block 410.

Initial functional behavior of 400 is similar to 200 with respect to mutual authentication, loading the CP key, decrypting the CA encrypted content received from host media processor 302 by CA decrypt block 210 and encrypting it again by CP encrypt block 212, and finally decrypting the CP encrypted content by CP decrypt block 404. Host media processor 302 further encrypts the CP decrypted content using private CP encrypt block 406. Private CP encrypt block 406 receives CP decrypted content via signal 426 and provides private CP encrypted content to transcoder 304 via a signal 428.

Transcoder 304 decrypts the private CP encrypted content using private CP decrypt block 408 to generate decrypted content 403. Transcoding portion 405 transcodes decrypted content 403 from a first format into a second format as transcoded content 407. Private CP encrypt block 412 then encrypts transcoded content 407 as private CP encrypted content. Private CP encrypt block 412 then sends private CP encrypted content back to host media processor 302 via signal 430. Private CP decrypt block 414 receives this private CP encrypted content and decrypts it.

Private security/authentication block 410 receives a private certificate Chain A 420 via signal 432. Similarly, private security/authentication block 416 receives a private certificate from private certificate Chain A 418 via signal 434. Private security/authentication block 410 and private security/authentication block 416 communicate with each other via CPU interface signals 436 and 438 in order to establish mutual authentication and secure CP key exchange.

Another non-limiting example of authenticating between a host media processor and a transcoder involves the secure ‘preloading’ of secret keys into the transcoder and the host media processor at the time of manufacture. With this type of authentication arrangement, the transcoder and the host media processor would thus be paired and may then securely communicate without the need to exchange certifications/keys. Accordingly, with this type of authentication arrangement, there would be no need for a secure CP exchange between transcoder 304 and host media processor 302, for example by way of CPU interface signal 438.

As discussed above with reference to FIGS. 3-4, the introduction of transcoder 304 requires additional steps of privately CP encrypting the content, decrypting it, transcoding it and re-encrypting it before sending it back to host media processor 302. The placement of transcoder 304 at the output of host media processor 302 provides a less efficient solution as explained below.

Incorporating a transcoder in STB involves multiple challenges. In order to transfer the content between the transcoder and the host media processor, it is common to use an industry standard interface like USB, PCI, PCIe, however, these resources may be needed for other purposes as well and cannot be dedicated to only interfacing with the transcoder. Additionally, without any extra hardware assistance, the processing system within STB may not be able to efficiently deliver and receive multiple content streams to and from the transcoder. Furthermore, the content delivered to and received from the transcoder must be encrypted for copy protection. In order to encrypt and decrypt the content, sufficient resources within the STB must be available to perform this heavy processing burden.

In accordance with an aspect of the present invention, the transcoder is disposed between between the conditional access device and the host media processor. With this type of arrangement, number of encryptions/decryptions is reduced without compromising the security of the content. This will now be described in greater detail with reference to FIGS. 5 and 6.

FIG. 5 illustrates a STB configuration 500 with an inline transcoder, in accordance with an aspect of the invention.

As illustrated in the figure, STB configuration 500 includes all the elements of FIG. 3, except host media processor 302 has been replaced by host media processor 502 and transcoder 304 has been replaced by transcoder 504. STB configuration 500 additionally includes a tuner 506.

Operation of M-card with respect to OOB modulator 106 and OOB demodulator 108 is similar to as described with reference to FIG. 1. Diplex filter 104 now provides output signal 130 to tuner 112, tuner 114 and tuner 506. Operation of tuner 506 is similar to tuner 112 and tuner 114 and has been added here to represent that by placing transcoder 504 on M-card 110 return path freed up a transport resource to allow another tuner to host media processor 502 in this configuration.

Placing the transcoder in between M-card 110 and host media processor 502 solves the issue of encrypting the contents going into the transcoder and decrypting the contents out of the transcoder. M-card 110 is already responsible for encrypting all High Value content that it processes. In the proposed configuration, M-card 110 will continue to encrypt High Value content similar to configurations discussed with reference to FIG. 1 and FIG. 3. Transcoder 504 will decrypt the content received on signal 140 from M-card 110 prior to transcoding. After the transcoding operation is complete, transcoder 504 will re-encrypt the content using the same encryption keys that it used for decryption, thereby re-protecting the content on the way to host media processor 502 via signal 508. Host media processor 502 will decrypt the content as if it had come directly from M-card 110, using the same decryption resources that it would use in the configuration of FIG. 1.

Control interface 308 is still required in configuration 500 between transcoder 504 and host media processor 502. Some non-limiting examples of this interface include USB, PCIe, serial port or any other suitable interface. Host media processor 502 uses control interface 308 to download any code modules required by transcoder 504 to operate, to establish operating parameters for transcoder 504, and to provide the keys to transcoder 504 to enable the encryption and decryption of the protected content. This is further explained using FIG. 6.

FIG. 6 illustrates a functional diagram for STB configuration 500, in accordance with an aspect of the invention.

FIG. 6 includes few elements of FIG. 2, namely, M-card 110, card certificate 202, host certificate 204 and cable head-end command and control block 23. Additionally, it includes transcoder 504, host media processor 502, private certificate chain A 418 and private certificate chain A 420. Transcoder 504 further includes a CP decrypt block 602, a private security/authentication block 604, a transcoding portion 605 and a CP encrypt block 606. Host media processor 502 further includes a CP processing block 608, a CP decrypt block 610 and a private security/authentication block 612.

In this example, each of CP decrypt block 602, private security/authentication block 604, transcoding portion 605 and CP encrypt block 606 are distinct devices. However, in other embodiments, at least two of CP decrypt block 602, private security/authentication block 604, transcoding portion 605 and CP encrypt block 606 may be combined as a unitary device. Further, in some embodiments at least one of CP decrypt block 602, private security/authentication block 604 and CP encrypt block 606 may be implemented as computer-readable media for carrying or having computer-executable instructions or data structures stored thereon.

In this example, each of CP processing block 608, CP decrypt block 610 and private security/authentication block 612 are distinct devices. However, in other embodiments, at least two of CP processing block 608, CP decrypt block 610 and private security/authentication block 612 may be combined as a unitary device. Further, in some embodiments at least one of CP processing block 608, CP decrypt block 610 and private security/authentication block 612 may be implemented as computer-readable media for carrying or having computer-executable instructions or data structures stored thereon.

As illustrated in the figure, transcoder 504 is placed in between M-card 110 and host media processor 502. Function of transcoder 504 is to convert the media content from one digital video format for example, MPEG2 to another digital video format like MPEG4. In this proposed configuration, binding process still takes place according to OP-SP-CCCP2.0 Specification.

M-card 110 is operable to function as explained earlier with reference to FIG. 2 and FIG. 4. Host media processor 502 communicates with M-card 110 for mutual authentication and CP key generation as discussed earlier with reference to FIG. 2 and FIG. 4. Since transcoder 504 sits in between M-card 110 and host media processor 502, it needs to perform secondary encryption by first CP decrypting the CP encrypted content received from M-card 110, transcoding it and then CP encrypting it again before providing it to host media processor 502. Transcoder 504 must therefore contain the security function necessary to decrypt and re-encrypt the content. In order for the system to function properly, host media processor 502 and transcoder 504 perform a mutual authentication function and a secured function for passing the CP key. Private security/authentication block 604 and private security/authentication block 612 perform the mutual authentication via interface signal 436 and a secure CP key exchange via interface signal 438. Note that private security/authentication blocks can be implemented using any of the well-known security method, which provide authentication and secure channel communication. A non-liming example of such a security system is a public/private key system chained to separate certificates like Private Certificate Chain A 418 and Private Certificate Chain A 420.

Similar to STB 300 discussed above with reference to FIG. 4, another non-limiting example of authenticating between a host media processor and a transcoder in accordance with aspects of the present invention involves the secure ‘preloading’ of secret keys into the transcoder and the host media processor at the time of manufacture. With this type of authentication arrangement, the transcoder and the host media processor would thus be paired and may then securely communicate without the need to exchange certifications/keys. Accordingly, with this type of authentication arrangement, there would be no need for a secure CP exchange between transcoder 504 and host media processor 502, for example by way of CPU interface signal 438.

Transcoder 504 decrypts the private CP encrypted content using CP decrypt block 602 to generate decrypted content 603. Transcoding portion 605 transcodes decrypted content 603 from a first format into a second format as transcoded content 607. CP encrypt block 606 then encrypts transcoded content 607 as CP encrypted-transcoded content 614. CP encrypt block 606 then sends CP encrypted-transcoded content 614 back to host media processor 502. CP decrypt block 610 receives encrypted-transcoded content 614 and decrypts it. Since transcoder 504 is placed in between M-card 110 and host media processor 502, the extra steps of private CP encrypting and decrypting the content as shown by private CP encrypt block 406 and private CP decrypt block 414 are not required in the proposed configuration.

Since host media processor 502 cannot receive high value content until it has completed binding with M-card 110 using OP-SP-CCCP2.0 specifications, the secondary encryption between transcoder 504 and host media processor 502 is dependent on OP-SP-CCCP2.0 process. Without binding, or in the event that a particular host certificate has been revoked, no High Value content will be transmitted, and host media processor 502 has no CP key to share with transcoder 504. In the event when private certificates are used between transcoder 504 and host media processor 502, the chain can also be validated and revoked via private and remote means, which can also be used to enable and disable the Private CP process between transcoder 504 and host media processor 502.

As discussed above with reference to FIG. 5 and FIG. 6, in accordance with an aspect of the present invention, transcoder 504 is placed in between M-card 110 and host media processor 502. The binding process between M-card 110 and host media processor 502 still takes place using OP-SP-CCCP2.0 specifications. Since transcoder 504 is placed in between M-card 110 and host media processor 502, it first CP decrypts the media content, transcodes it and then CP re-crypts it before passing it to host media processor 502. Transcoder 504 is required to contain necessary security functions in order to be able to decrypt and encrypt the content. The proposed configuration requires much lower use of encryption and decryption processing resources by saving the additional steps of CP decrypting and CP re-encrypting the content as compared to STB 300 configuration.

A benefit of an STB configuration in accordance with aspects of the present invention will now be described with a comparison of the processes of STB 300 with a transcoder of FIG. 4 and STB with a transcoder configuration 500 of FIG. 6

FIG. 7 is a timing diagram, illustrating the relative time of processes of M-card 110, host media processor 302 and transcoder 304 of STB 300 with a transcoder of FIG. 4.

As illustrated in FIG. 7, M-card 110 and host media processor 302 are mutually authenticated as represented by bi-directional arrow 702, which corresponds to mutual authentication and Diffie Hellman exchange information 220 of FIG. 4. Then M-card 110 and host media processor 302 generate a CP key as represented by bi-directional arrow 704, which corresponds to the generation of CP key of FIG. 4. Then host media processor 302 sends encrypted content to M-card 110 as represented by arrow 706, which corresponds to the sending of encrypted content 224 of FIG. 4.

At this point, M-card 110 decrypts the content as represented by circle 708. Then M-card 110 encrypts the content as represented by dot 710, which corresponds to CP encrypt block 212 deciding whether CA decrypted data 230 needs to be re-encrypted, as discussed above with reference to FIG. 4. In this case, presume that the data is re-encrypted by CP encrypt block 212.

Now, M-card 110 sends the encrypted content to host media processor 302 as represented by arrow 712, which corresponds to CP encrypted content 226 of FIG. 4. At this point, host media processor 302 decrypts the content as represented by circle 714, which corresponds to CA decrypt block 404 receiving CA encrypted content 226 from M-card 110 of FIG. 4. If the encoded content needs to be converted into another format, then it should be sent to transcoder 304. However, the content must be protected. As such, before the content is sent to transcoder 304, host media processor 302 encrypts the content as represented by dot 716, which corresponds to CP encrypt block 406 of FIG. 4. Then the encrypted content is then sent to transcoder 304 as represented by arrow 718, which corresponds to signal 428 of FIG. 4.

Transcoder 304 decrypts the content as represented by circle 720, which corresponds to CA decrypt block 408 of FIG. 4. Transcoder 304 then converts the decrypted content into another format, as represented by X 722. At this point transcoder 304 should return the transcoded content to host media processor 302. However, the transcoded content must be protected. As such, before the transcoded content is sent to host media processor 302, transcoder 304 encrypts the transcoded content as represented by dot 724, which corresponds to CP encrypt block 412 of FIG. 4. Then the encrypted transcoded content is then sent to host media processor 302 as represented by arrow 726, which corresponds to signal 430 of FIG. 4.

Host media processor 302 then decrypts the transcoded content as represented by circle 728, which corresponds to CA decrypt block 414 of FIG. 4. Host media processor 302 then plays the transcoded content, as represented by +sign 730.

A benefit of the STB configuration in accordance with aspects of the present invention will now be described with reference to FIG. 8.

FIG. 8 is a timing diagram, illustrating the relative time of processes of M-card 110, host media processor 502 and transcoder 604 of STB configuration 500 of FIG. 6.

As illustrated in FIG. 8, M-card 110 and host media processor 502 are mutually authenticated as represented by bi-directional arrow 702, which corresponds to mutual authentication and Diffie Hellman exchange information 220 of FIG. 6. Then M-card 110 and host media processor 302 generate a CP key as represented by bi-directional arrow 704, which corresponds to the generation of CP key of FIG. 6. Then host media processor 302 sends encrypted content to M-card 110 as represented by arrow 706, which corresponds to the sending of encrypted content 224 of FIG. 6.

At this point, M-card 110 decrypts the content as represented by circle 708, which corresponds to CA decrypt block 210 receiving CA encrypted content 224 from host media processor 116, which has been encrypted by any known method as discussed above with reference to FIG. 6. Then M-card 110 encrypts the content as represented by dot 710, which corresponds to CP encrypt block 212 deciding whether CA decrypted data 230 needs to be re-encrypted, as discussed above with reference to FIG. 6. In this case, presume that the data is re-encrypted by CP encrypt block 212.

Now, M-card 110 sends the encrypted content to transcoder 504 as represented by arrow 802, which corresponds to CP encrypted content 226 of FIG. 6. At this point, Transcoder 504 decrypts the content as represented by circle 804, which corresponds to CA decrypt block 602 of FIG. 6. Transcoder 504 then converts the decrypted content into another format, as represented by X 806. At this point transcoder 504 should send the transcoded content to host media processor 502. However, the transcoded content must be protected. As such, before the transcoded content is sent to host media processor 502, transcoder 504 encrypts the transcoded content as represented by dot 810, which corresponds to CP encrypt block 606 of FIG. 6. Then the encrypted transcoded content is then sent to host media processor 502 as represented by arrow 812, which corresponds to signal 614 of FIG. 6.

Host media processor 502 then decrypts the transcoded content as represented by circle 814, which corresponds to CA decrypt block 610 of FIG. 6. Host media processor 502 then plays the transcoded content, as represented by +sign 816.

The processing savings of an STB configuration in accordance with aspects of the present invention are very clear when comparing FIG. 7 to FIG. 8, which corresponds to a comparison of STB 300 with a transcoder of FIG. 4 to STB with a transcoder configuration 500 of FIG. 6. In particular, in STB 300 with a transcoder configuration of FIG. 4, there are four decoding processes (represented by circles 708, 714, 720 and 728) and three encoding processes (represented by dots 710, 716 and 724). However, in STB 300 with a transcoder configuration of FIG. 6, there are only three decoding processes (represented by circles 708, 804 and 814) and only two encoding processes (represented by dots 710 and 810). As such, an STB configuration in accordance with aspects of the present invention reduces the required processing for one encrypting process and one decrypting process while maintaining security of the content.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A system for use with secure content in a first format, said system comprising:
a conditional access device arranged to receive the secure content and operable to generate second secure content based on the secure content;
a transcoding device; and
a media processor,
wherein said conditional access device is further operable to provide the second secure content to said transcoding device,
wherein said transcoding device is operable to transcode the second secure content into transcoded content of a second format, to secure the transcoded content as secure transcoded content and to provide the secure transcoded content to said media processor.

2. The system of claim 1,
wherein said conditional access device is arranged to receive the secure content as encrypted content and is operable to generate the second secure content as second encrypted content based on the encrypted content and to provide the second secure content to said transcoding device as second encrypted content,
wherein said transcoding device includes a decrypting portion, a transcoding portion and an encrypting portion,
wherein said decrypting portion is arranged to receive the second encrypted content from said conditional access device and is operable to decrypt the second encrypted content into decrypted content of the first format,
wherein said transcoding portion operable to transcode the decrypted content into transcoded content of a second format,
wherein said encrypting portion is operable to secure the transcoded content as secure transcoded content by encrypting the transcoded content as encrypted transcoded content and to provide the secure transcoded content to said media processor by providing the encrypted transcoded content to said media processor, and
wherein said media processor is operable to decrypt the encrypted transcoded content.

3. The system of claim 2,
wherein said conditional access device includes a conditional access device decrypting portion and a conditional access device encrypting portion,
wherein said conditional access device decrypting portion is arranged to receive the encrypted content from said media processor and is operable to decrypt the encrypted content into CA decrypted content, and
wherein said conditional access device encrypting portion is arranged to receive the CA decrypted content and is operable to re-encrypt the CA decrypted content as the second encrypted content.

4. The system of claim 3,
wherein said conditional access device further includes a copy protection processing portion,
wherein said media processor includes a media processor copy protection processing portion,
wherein said copy protection processing portion and said media processor copy protection processing portion are operable to generate an encryption key, and
wherein said conditional access device encrypting portion is operable to re-encrypt the CA decrypted content as the second encrypted content using the encryption key.

5. The system of claim 4,
wherein said media processor copy protection processing portion is operable to provide the encryption key to said transcoding device,
wherein said decrypting portion is operable to decrypt the second encrypted content into decrypted content of the first format using the encryption key, and
wherein said encrypting portion operable to encrypt the transcoded content as encrypted transcoded content using the encryption key.

6. The system of claim 5, wherein said media processor further includes a media processor decrypting portion arranged to receive the encrypted transcoded content from said encrypting portion and operable to decrypt the encrypted transcoded content using the encryption key.

7. A method of using secure content in a first format, said system comprising:
receiving, via a conditional access device, the secure content;
generating, via the conditional access device, second secure content based on the secure content;
transcoding, via a transcoding device, the second secure content into transcoded content of a second format;
securing, via the transcoding device, the transcoded content as secure transcoded content; and
receiving, via a media processor, the secure transcoded content.

8. The method of claim 7, further comprising:
accessing, via the media processor, the secure transcoded content,
wherein said receiving, via a conditional access device, the secure content comprises receiving, via the conditional access device, the secure content as encrypted content;
wherein said generating, via the conditional access device, second secure content based on the secure content comprises generating, via the conditional access device, second secure content as second encrypted content based on the encrypted content;
wherein said transcoding, via a transcoding device, the second secure content into transcoded content of a second format comprises receiving the second encrypted content via a transcoding device including a decrypting portion, a transcoding portion and an encrypting portion, the second encrypted content, decrypting, via the decrypting portion, the second encrypted content into decrypted content of the first format and transcoding, via the transcoding portion, the decrypted content into transcoded content of a second format;
wherein said securing, via the transcoding device, the transcoded content as secure transcoded content comprises encrypting, via the encrypting portion, the transcoded content as encrypted transcoded content, and
wherein said accessing, via the media processor, the secure transcoded content comprises decrypting, via the media processor, the encrypted transcoded content.

9. The method of claim 8, wherein said generating, via the conditional access device, second encrypted content based on the encrypted content comprises:
receiving, via a conditional access device decrypting portion, the encrypted content from a media processor;
decrypting, via the conditional access device decrypting portion, the encrypted content into CA decrypted content, and
re-encrypting, via a conditional access device encrypting portion, the CA decrypted content as the second encrypted content.

10. The method of claim 9, further comprising:
generating an encryption key via a copy protection processing portion within the conditional access device and a media processor copy protection processing portion within the media processor, and
wherein said re-encrypting, via a conditional access device encrypting portion, the CA decrypted content as the second encrypted content comprises re-encrypting, via the conditional access device encrypting portion, the CA decrypted content as the second encrypted content using the encryption key.

11. The method of claim 10, further comprising:
providing, via the media processor copy protection processing portion, the encryption key to the transcoding device,
wherein said decrypting, via the decrypting portion, the second encrypted content into decrypted content of the first format comprises decrypting, via the decrypting portion, the second encrypted content into decrypted content of the first format using the encryption key, and
wherein said encrypting, via the encrypting portion, the transcoded content as encrypted transcoded content comprises encrypting, via the encrypting portion, the transcoded content as encrypted transcoded content using the encryption key.

12. The method of claim 11, wherein said decrypting, via a media processor, the encrypted transcoded content comprises decrypting, via a third decrypting portion, the encrypted transcoded content using the encryption key.

13. A tangible computer-readable media having computer-readable instructions stored thereon, the computer-readable instructions being capable of being read by a computer to be used with encrypted content in a first format, the computer-readable instructions being capable of instructing the computer to perform the method comprising:
receiving, via a conditional access device, the secure content;
generating, via the conditional access device, second secure content based on the secure content;
transcoding, via a transcoding device, the second secure content into transcoded content of a second format;
securing, via the transcoding device, the transcoded content as secure transcoded content; and
receiving, via a media processor, the secure transcoded content.

14. The tangible computer-readable media of claim 13, the computer-readable instructions being capable of instructing the computer to perform said method further comprising:
accessing, via the media processor, the secure transcoded content,
wherein said receiving, via a conditional access device, the secure content comprises receiving, via the conditional access device, the secure content as encrypted content,
wherein said generating, via the conditional access device, second secure content based on the secure content comprises generating, via the conditional access device, second secure content as second encrypted content based on the encrypted content,
wherein said transcoding, via a transcoding device, the second secure content into transcoded content of a second format comprises receiving the second encrypted content via a transcoding device including a decrypting portion, a transcoding portion and an encrypting portion, the second encrypted content, decrypting, via the decrypting portion, the second encrypted content into decrypted content of the first format and transcoding, via the transcoding portion, the decrypted content into transcoded content of a second format,
wherein said securing, via the transcoding device, the transcoded content as secure transcoded content comprises encrypting, via the encrypting portion, the transcoded content as encrypted transcoded content, and
wherein said accessing, via the media processor, the secure transcoded content comprises decrypting, via the media processor, the encrypted transcoded content.

15. The tangible computer-readable media of claim 14, wherein the computer-readable instructions being capable of instructing the computer to perform said generating, via the conditional access device, second encrypted content based on the encrypted content comprises instructions being capable of instructing the computer to perform:
receiving, via a conditional access device decrypting portion, the encrypted content from a media processor;
decrypting, via the conditional access device decrypting portion, the encrypted content into CA decrypted content, and
re-encrypting, via a conditional access device encrypting portion, the CA decrypted content as the second encrypted content.

16. The tangible computer-readable media of claim 15, the computer-readable instructions being capable of instructing the computer to perform said method further comprising:
generating an encryption key via a copy protection processing portion within the conditional access device and a media processor copy protection processing portion within the media processor, and
wherein said re-encrypting, via a conditional access device encrypting portion, the CA decrypted content as the second encrypted content comprises re-encrypting, via the conditional access device encrypting portion, the CA decrypted content as the second encrypted content using the encryption key.

17. The tangible computer-readable media of claim 16, the computer-readable instructions being capable of instructing the computer to perform said method further comprising:
providing, via the media processor copy protection processing portion, the encryption key to the transcoding device,
wherein said decrypting, via the decrypting portion, the second encrypted content into decrypted content of the first format comprises decrypting, via the decrypting portion, the second encrypted content into decrypted content of the first format using the encryption key, and
wherein said encrypting, via the encrypting portion, the transcoded content as encrypted transcoded content comprises encrypting, via the encrypting portion, the transcoded content as encrypted transcoded content using the encryption key.

18. The tangible computer-readable media of claim 17, wherein the computer-readable instructions being capable of instructing the computer to perform said decrypting, via a media processor, the encrypted transcoded content comprises computer-readable instructions being capable of instructing the computer to perform decrypting, via a third decrypting portion, the encrypted transcoded content using the encryption key.
